(19) United States
(12) Patent Application Publication
(10) Pub. No.: US 2004/0235972 A1
(43) Pub. Date: Nov. 25, 2004

(54) Rigid polyurethane foam product formed using mold

(76) Inventor: Toshiyuki Horimatsu, Yokohama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,363

(22) PCT Filed: Oct. 28, 2002
(86) PCT No.: PCT/JP02/11128

(30) Foreign Application Priority Data
Oct. 29, 2001 (JP) 2001-331039

(51) Int. Cl. C08J 9/00; C08G 18/00

(52) U.S. Cl. 521/155

(57) ABSTRACT

A rigid polyurethane foam molded product which is excellent in dimensional accuracy and also in stability of the dimensional accuracy can be provided by allowing reaction heat generated during rigid polyurethane raw material is foamed to effectively escape to the outside. The molded product 1 is produced by injecting the rigid polyurethane raw material into a mold and foaming the rigid polyurethane raw material. The molded product 1 is provided at its volume zone 2 with a reaction heat relief portion composed of a pit or a through hole communicating with an outer surface 3 of the molded product 1. The ratio of the volume of the reaction heat relief portion to the apparent volume of the molded product is from 0.01 to 0.5. The molded product is suitably adopted to an energy absorbing member.

### CROSS REFERENCE TO RELATED APPLICATION

This is a continuation application of PCT/JP02/11128 filed on Oct. 28, 2002.

### FIELD OF THE INVENTION

The present invention relates to a rigid polyurethane foam molded product.

### BACKGROUND OF THE INVENTION

For impact energy absorption (EA) in the event of a lateral collision, an EA member composed of a rigid polyurethane foam is mounted on a door trim of an automobile. The EA member composed of a rigid polyurethane foam is manufactured by injecting the rigid polyurethane raw material into a mold and foaming the rigid polyurethane raw material. The EA member is mounted with being sandwiched between a vehicle body skin and an interior part so that the EA member is required to have good dimensional accuracy. If the dimensional accuracy of the EA member is not good, the mounting portion of the EA member may not be fixed or the fitting between surfaces may be poor leading to faulty adhesion.

The important characteristics of rigid polyurethane foam molded products are hardness and density. The hardness and the density of foam obtained from rigid polyurethane raw material of same compound are linearly correlated with each other. Therefore, by controlling the amount of the raw material to be injected into a mold, the hardness and the density of thus obtained foam can be controlled.

The ratio of the density D_{M} of a molded product to the density D_{O} of foam which is obtained by foaming the rigid polyurethane raw material in the free state without being injected in a mold, that is, “D_{M}/D_{O}” is referred to as “pack ratio”. A product having a high pack ratio has high density and high hardness, but poor dimensional accuracy. This is because the reaction heat generated during foaming is accumulated inside the molded product. That is, since the rigid polyurethane foam has low thermal conductivity, the heat generated during foaming hardly escapes to the outside so that the heat is easily accumulated inside the molded product and the product in the mold has high temperature inside. As the product having high temperature is taken out of the mold, the product is expanded due to thermal expansion. In the event of severe case, cracks are created.

This phenomenon arises especially in central portion of its volume zone. Volume zone means a region of the molded product where the maximum cube can be obtained if it is cut out. At surface area of the molded product abutting on the walls of the mold, the reaction heat easily escapes to the outside through the surface of the mold. In the volume zone, however, the reaction heat is easily accumulated.

FIGS. 3a, 3b are sectional views showing a conventional molding method. As shown in FIG. 3a, a molded product 12 is in a mold 11 comprising an upper die 11a and a lower die 11b. Reaction heat generated in outer layer portions of the molded product 12 abutting on the walls of the mold 11 escapes through the mold 11. However, reaction heat generated in the central portion of the volume zone of the molded product 12 escapes little due to excellent heat insulation efficiency of rigid polyurethane foam and is accumulated at the inside 12A of the molded product 12 so that the inside of the molded product 12 is maintained at a high temperature. As the molded product 12 having the high temperature inside 12A thereof is taken out of the mold 11, the mold product 12 is expanded due to thermal expansion as shown in FIG. 3b. Accordingly, the molded product 12 has larger dimensions than the designed dimensions shown by dashed lines, impairing the dimensional accuracy.

To prevent the reduction in dimensional accuracy of rigid polyurethane foam due to reaction heat, the following measurements may be taken:

(i) Controlling composition of the rigid polyurethane raw material to lower reaction heat. For example, reducing the foaming rate of the rigid polyurethane raw material lowers the pack ratio.

This method can be employed only in a case that there is some degree of freedom of the equipment for blending the rigid polyurethane raw material. Further, in case of large size molded product, the available pack ratio is limited, impairing the degree of freedom of molding.

(ii) Forming the mold into a configuration previously including estimation in order to prevent the reduction in dimensional accuracy of the molded product due to expansion after taken out of the mold. That is, the configuration (or dimensions) of the mold is designed anticipating the expansion of the product after taken out of the mold in the same point of view as shrinkage.

In this case, because of difference between actual expansion dimensions and the anticipated dimensions of the mold, there must be product-to-product variations in dimensions so that the dimensional stability is poor.

(iii) Making the cells of rigid polyurethane foam into opened cells so as to allow internal pressure developed by the increase in internal temperature due to reaction heat to escape to the outside through the opened cells.

This method requires special design of the mold to allow gas generated inside the molded product to escape from the mold in the sealed state to the outside. Since nearly all of molded products have high-density skin layer as the outer layer, gas permeation takes much time. This method can not be adopted to molded products of short-time molding cycle.

### SUMMARY OF THE INVENTION

A rigid polyurethane foam molded product of the present invention is produced by injecting the rigid polyurethane raw material into a mold and foaming the rigid polyurethane raw material, and is provided in its volume zone with a reaction heat relief portion, composed of a pit or a through hole communicating with an outer surface of the molded product, for allowing the escape of reaction heat generated during the foaming.

### BRIEF DESCRIPTION OF THE DRAWINGS

FIG. 1a is a perspective view of a rigid polyurethane foam molded product according to an embodiment, and FIG. 1b is a plan view of the same;

FIG. 2 is a perspective view of a rigid polyurethane foam molded product according to another embodiment;

FIG. 3a is a sectional view of a conventional rigid polyurethane foam molded product during molding process, FIG. 3b is a schematic sectional view of the same when being taken out of a mold;

FIGS. 4a, 4b are schematic sectional views of a rigid polyurethane foam molded product according to an embodiment; and

FIGS. 5a-5f are perspective views of rigid polyurethane foam molded products according to different embodiments, respectively.

### DESCRIPTION OF THE PREFERRED EMBODIMENTS

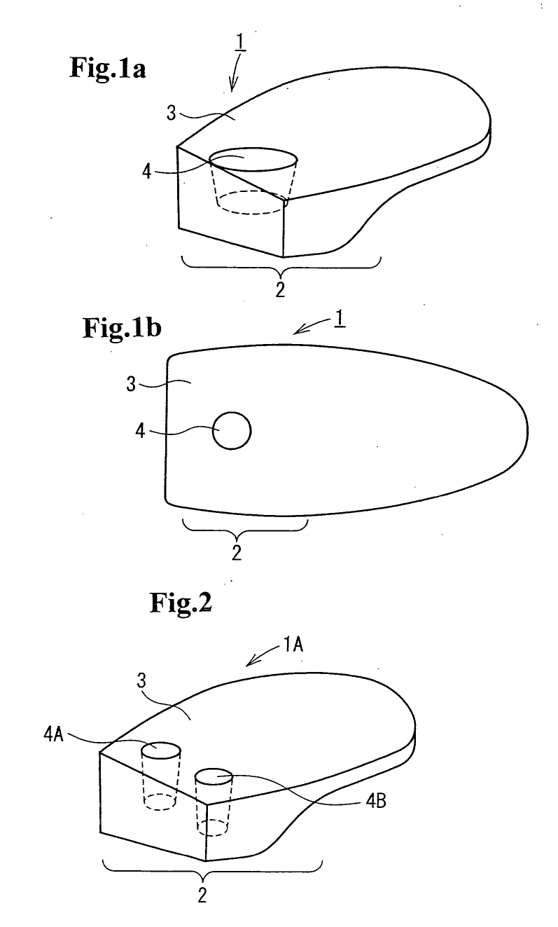

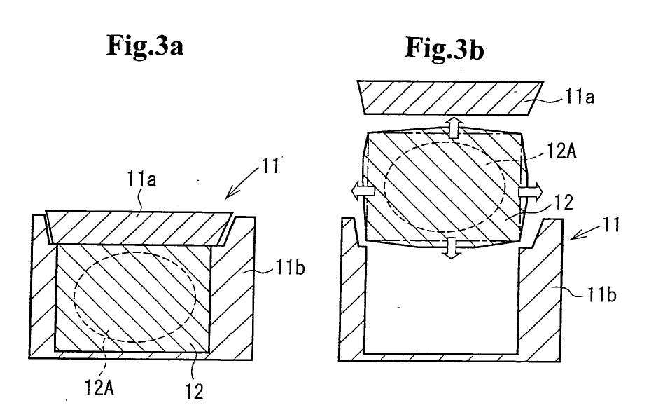

FIGS. 1a, 1b show a rigid polyurethane foam molded product according to an embodiment and FIG. 2 is a rigid polyurethane foam molded product according to another embodiment.

The rigid polyurethane foam molded product 1 shown in FIGS. 1a, 1b is provided in a volume zone with a single through hole 4, as a reaction heat relief portion, communicating with an outer surface 3 of the molded product. The rigid polyurethane foam molded product 1A shown in FIG. 2 is provided in a volume zone 2 with two through holes 4A, 4B communicating with an outer surface 3 of the molded product.

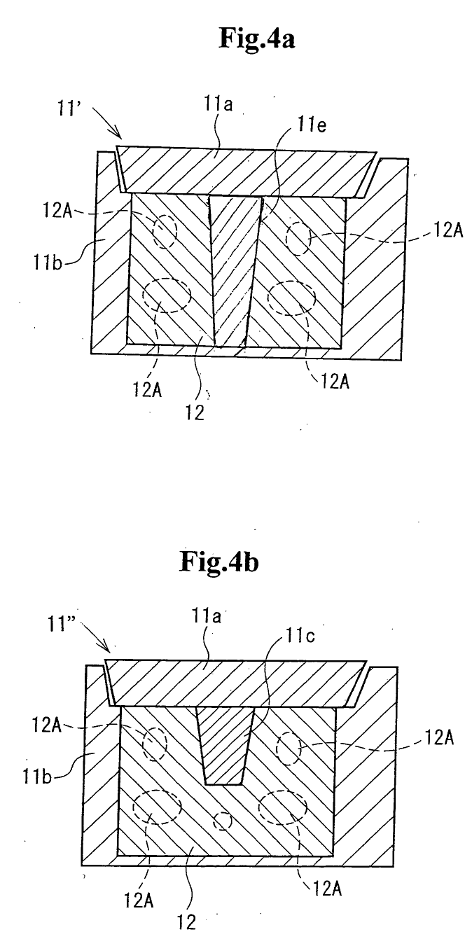

The rigid polyurethane foam molded products 1, 1A are produced by using a mold 11′ having a projection(s) 11e corresponding to the through hole 4 or through holes 4A, 4B as shown in FIG. 4a.

The projection(s) 11e is provided for forming the through hole 4 or the through holes 4A, 4B in the volume zone of the molded products 1, 1A and extends such that the lower end of the projection 11e comes in contact with a lower die 11b. Reaction heat inside the volume zone of the molded product 12 escapes through the projection(s) 11e. Accordingly, in the molded product 12, small accumulated portions 12A where reaction heat is accumulated are formed in dispersed positions as shown by chain lines in FIG. 4a. Because the accumulated portions 12A are small and dispersed, there is no possibility of developing large expansion force when the product is taken out of the mold. Therefore, a molded product having excellent dimensional accuracy is formed.

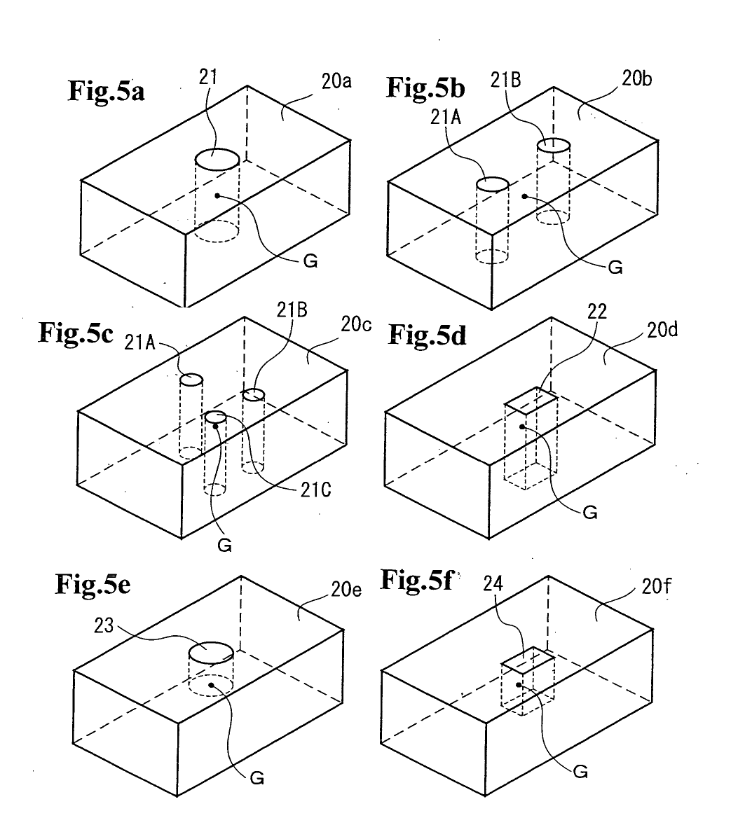

FIGS. 5a through 5f show different embodiments, respectively. In these drawings, mark G designates the center of a volume zone. A molded product 20a shown in FIG. 5a has a cylindrical through hole 21, as a reaction heat relief portion, penetrating from one face to the other face. A molded product 20b shown in FIG. 5b has two through holes 21A, 21B. A molded product 20c shown in FIG. 5c has three through holes 21A, 21B, and 21C. A molded product 20d shown in FIG. 5d has a square columnar through hole 22. A molded product 20e shown in FIG. 5e has a cylindrical pit 23, as a reaction heat relief portion. A molded product 20f shown in FIG. 5f has a square columnar pit 24.

A mold 11″ for producing a molded product having a pit is shown in FIG. 4b. A projection 11c extending from an upper die 11a forms the pit in the molded product. The projection 11c is shorter than the projection 11e of FIG. 4a and the lower end of the projection 11c is spaced apart from the lower die 11b.

The shape and the number of reaction heat relief portion(s) composed of through hole(s) or pit(s) are not limited to the illustrated examples. Instead of circle or square as shown in FIGS. 1a, 1b, 2, 5a through 5f, the section shape of the reaction heat relief portion may be oval, triangle, pentagon, star, or the like. The number of the reaction heat relief portions may be four or more. Both a pit as the reaction heat relief portion and a through hole as the reaction heat relief portion may be formed in one molded product.

In case of forming a single reaction heat relief portion, the reaction heat relief portion is preferably formed to extend through the center or some portion near the center of the volume zone of the molded product. In case of forming two or more reaction heat relief portions, the reaction heat relief portions are preferably arranged evenly in the volume zone so as to reduce accumulated reaction heat.

Since the reaction heat relief portion composed of a pit or a through hole formed in a molded product reduces the strength of the molded product, the reaction heat relief portion is preferably not so large. Assuming a plane confronting the outer surface communicating with the reaction heat relief portion as the projection plane, the reaction heat relief portion is preferably designed to satisfy that the ratio of the projected area S₁ of the reaction heat relief portion on the projection plane to the projected area S₂ of the molded product on the projection plane, i.e. S₁/S₂, is 0.2 or less. However, in view of the effect of increasing the heat radiation by the reaction heat relief portion, the aforementioned projected area ratio S₁/S₂ is preferably 0.01 or more.

For the same reason, the ratio of the volume V₁ of the reaction heat relief portion composed of a pit or a through hole to the apparent volume V₂ of the molded product (the apparent volume V₂ means the total of the actual volume of the molded product and the volume of the reaction heat relief portion), i.e. V₁/V₂, is preferably from 0.01 to 0.5, more preferably from 0.05 to 0.3.

The rigid polyurethane foam molded product of the present invention as mentioned above is suitably adopted to a molded product of which pack ratio is high, particularly 1.2 or more, more particularly from 1.3 to 2.5, so as to easily accumulate reaction heat in its volume zone.

After producing a molded product, an insertion member separately formed in a configuration corresponding to its reaction heat relief portion may be inserted into the reaction heat relief portion. In this case, the reaction heat relief portion may have a projected area ratio S₁/S₂ larger than the aforementioned projected area ratio S₁/S₂ and a volume ratio V₁/V₂ larger than the aforementioned volume ratio V₁/V₂.

The rigid polyurethane foam molded product of the present invention can be advantageously adopted to a molded product having large volume zone so as to easily accumulate reaction heat in the volume zone, for example, a molded product having a volume zone from which a cube having a volume of 8 cm³ or more can be obtained if it is cut out.

The present invention is suitably adopted to, but not limited to, an EA member of which volume zone is large and which is required to have good dimensional accuracy.

As described in detail above, the rigid polyurethane foam molded product of the present invention can allow reaction heat, generated when the rigid polyurethane raw material is foamed in a mold, to effectively escape to the outside, thereby preventing the reaction heat from being accumulated inside the molded product. According to the present invention, the expansion of a molded product when taken out of a mold can be prevented, thereby providing a rigid polyurethane foam molded product which is excellent in dimensional accuracy.

1. A rigid polyurethane foam molded product which is produced by injecting the rigid polyurethane raw material into a mold and foaming the rigid polyurethane raw material, wherein
the molded product is provided in its volume zone with a reaction heat relief portion, composed of at least one of pits or through holes communicating with an outer surface of the molded product, for allowing the escape of reaction heat generated during the foaming.

2. A rigid polyurethane foam molded product as claimed in claim 1, wherein, assuming a plane confronting the outer surface communicating with the reaction heat relief portion as the projection plane, the projected area ratio of the projected area S1 of the reaction heat relief portion on the projection plane to the projected area S2 of the molded product on the projection plane, i.e. S1/S2, is 0.2 or less.

3. A rigid polyurethane foam molded product as claimed in claim 2, wherein the projected area ratio S1/S2 is from 0.01 to 0.2.

4. A rigid polyurethane foam molded product as claimed in claim 1, wherein the ratio of the volume V1 of the reaction heat relief portion to the apparent volume V2 of the molded product, i.e. V1/V2, is 0.5 or less.

5. A rigid polyurethane foam molded product as claimed in claim 4, wherein the volume ratio V1/V2 is from 0.01 to 0.5.

6. A rigid polyurethane foam molded product as claimed in claim 1, wherein the pack ratio of said rigid polyurethane raw material to the mold is 1.2 or more.

7. A rigid polyurethane foam molded product as claimed in claim 1, wherein the molded product is an energy absorbing member.

8. A rigid polyurethane foam molded product as claimed in claim 1, wherein said mold has a protrusion for forming the reaction heat relief portion.

9. A rigid polyurethane foam molded product as claimed in claim 8, wherein said mold comprises an upper die and a lower die and said protrusion is disposed on said upper die.
